(19) United States
(12) Patent Application Publication
(10) Pub. No.: US 2009/0148825 A1
(43) Pub. Date: Jun. 11, 2009

(54) APPARATUS, SYSTEM, AND METHOD FOR COORDINATING WEB-BASED DEVELOPMENT OF DRIVERS & INTERFACING SOFTWARE USED TO IMPLEMENT A MULTI-MEDIA TEACHING SYSTEM

(76) Inventor: Bernhard Dohrmann, Madison, AL (US)

Correspondence Address: Kunzler & McKenzie, 8 EAST BROADWAY, SUITE 600, SALT LAKE CITY, UT, 84111, US

(21) Appl. No.: 12/247,977

(22) Filed: Oct. 8, 2008

Related U.S. Application Data
(60) Provisional application No. 60/978,319, filed on Oct. 8, 2007.

(51) Int. Cl. G09B 5/00

(52) U.S. Cl. 434/307 R

(57) ABSTRACT

An apparatus, system, and method are disclosed for coordinating web-based development of drivers used to implement a multimedia teaching system. A system for multimedia teaching in accordance with the present invention includes a table of drivers, a hardware control, a service control manager, a registry, a database, a user, several pieces of hardware that facilitate the delivery of multimedia content, and several drivers for those pieces of hardware, which work together to present information to an audience. The system includes a collection module to collect identification and licenses from affiliates. An access module is included to access online design parameters. A monitoring module is included to receive and monitor the driver codes. A publishing module is included to publish the driver code into available software, as well as to make the software available online, while preventing access to later software. A distribution module is included to calculate a sum of fees for all participating parties.

### CROSS-REFERENCES TO RELATED APPLICATIONS

This application claims priority to U.S. Provisional Patent Application No. 60/978,319 entitled “Apparatus, System, and Method for Coordinating Web-based Development of Drivers Used to Implement a Multimedia Teaching System” and filed on Oct. 8, 2007 for Bernhard Dohrmann, which is incorporated herein by reference.

### BACKGROUND OF THE INVENTION

1. Field of the Invention

This invention relates to coordinating web-based drivers, and more particularly relates to drivers used to implement a multimedia teaching system.

2. Description of Related Art

Traditional class instruction focuses on an instructor lecturing at the front of a classroom while students take notes, but can often lead to mind wandering and distraction. There have been a limited number of software programs developed in order to curb the effects of a one-dimensional lecture, including programs by which the professor may display information in a variety of ways. The programs may allow for multimedia presentation, which allows the students to focus on different images during the lecture.

These programs comprise multimedia teaching systems, which are useful to classroom instruction. Although the programs exist, the professor, or user of the program, may be limited in the manner in which he or she operates the program. The user may be tied to strict parameters and an inadequate number of media outlets connected through the system. Additionally, the institutions of learning that wish to implement the teaching systems are often limited by outdated software and inefficient upgrades. The institutions are forced to re-use outdated systems that are disconnected from a source that may easily provide upgrades and new systems. The limited technology constricts the flexibility of multimedia teaching, as well teaching, as well as the actual use of multimedia teaching systems by universities, high schools, and other institutions of learning.

### SUMMARY OF THE INVENTION

From the foregoing discussion, it should be apparent that a need exists for an apparatus, system, and method that provide a more efficient way to coordinate a web-based development of drivers for a multimedia teaching system. Beneficially, such an apparatus, system, and method would allow institutions of learning to expand the utility, capabilities, and configurations of the multimedia teaching system.

The present invention has been developed in response to the present state of the art, and in particular, in response to the problems and needs in the art that have not yet been fully solved by currently available instruction methods. Accordingly, the present invention has been developed to provide an apparatus, system, and method for the coordination of a web-based development of drivers that allows institutions of learning to access and implement the software in a multimedia teaching system.

The apparatus to coordinate web-based development of drivers is provided with a multimedia teaching system and a coordinating apparatus. The multimedia teaching system comprises a service control manager, a database, hardware control and table of drivers, a registry, a server, a router, a lighting control system, a sound control system, lights, speakers, a projector, and a screen. The coordinating apparatus includes a plurality of modules configured to functionally execute the necessary steps of collecting affiliate identification and licenses, accessing the design parameters, monitoring the driver codes, publishing the approved software to an affiliate, and distributing calculations of fees.

A system of the present invention is also presented to coordinate web-based development of drivers. The system may be embodied by a multimedia teaching system and a web-based driver-development, coordinating apparatus. In particular, the multimedia teaching system includes a service control manager, a database, hardware control and table of drivers, a registry, a server, a router, a lighting control system, a sound control system, lights, speakers, a speakers, a projector, and a screen. In particular, the coordinating apparatus includes a collection module, an access module, a monitoring module, a publishing module, and a distribution module.

The system includes a table of drivers, which operate to control the pieces of hardware that facilitate the delivery of multimedia content, including the lights, projector, speakers, sound system, lighting control system, router, server, and screen. The table of drivers also provides an interface between the drivers on the table, the service control manager, the user, the registry, and the database. The system includes a service control manager, which comprises the software commands necessary to implement a session of multimedia instruction. The system employs a User who provides instructions to the hardware control.

The system includes a collection module that provides information to potential affiliates via the internet, about opportunities to develop code for hardware drivers used by the proprietary multimedia teaching system of FIG. 1. In one embodiment, the collection module may include a solicitation module, a licensing module, and an identification module. The solicitation module promulgates information by sending emails to administrators of universities and institutions of learning. In some embodiments, the emails contain links to a web-page. The licensing module displays the terms of the license agreement on a web-page. In certain embodiments, the licensing module includes a fee module. The identification module generates a username and password for the affiliate making the required payment and agreeing to the license agreement.

In one embodiment, the fee module in the license module provides a GUI, or other facilitator known to those in the relevant art, that facilitates the payment of a fee in connection with the license agreement. The fee module may provide for payment through encryption operation, or other methods known to those of skill in the relevant art, to protect information and to insure the secure transmission of funds.

The system includes an access module that provides online access to design parameters for drivers that can be integrated into the multimedia teaching system. The access module includes a password module, a parameter module, and a restriction module. The password module displays a GUI, or other facilitator known to those in the relevant art, requesting the username and password generated by the identification module. The parameter module displays to a web-page design parameters for the development of drivers. The parameter module may also display instructions and standards. The restriction module protects the core algorithms in the software supporting the multimedia teaching system.

The system includes a monitoring module that receives the driver code submitted by affiliates online. The monitoring module compares the driver code and the operations are administered by a monitor, which may be an institution of learning. In some embodiments, the monitoring module may include a sorting module, a testing module, and a standards module. The sorting module sorts submitted driver code into categories by the multimedia sub-systems or hardware to which the driver provides an interface. The testing module applies predefined tests to the driver code and collects results. The standards module compares the driver code against certain standards.

The system includes a publishing module that receives a driver code from the monitoring module and publishes the driver code in successive versions of the software that support the multimedia teaching system. The publishing module makes the successive versions of the software available online. In some embodiments, the publishing module includes an affiliate module that prevents access to subsequent versions of the software supporting the multimedia teaching system to licensed affiliates.

The system includes a distribution module that calculates the total sum for the fees collected by the collection module. The distribution module calculates percentages to be received by the monitor, or the owner of intellectual property rights, and for other parties. The distribution module facilitates an electronic transfer of funds so that each party receives its proper share of the total fees collected by the collection module.

A method of the present invention is also presented for coordinating web-based development of drivers. The method in the disclosed embodiments substantially includes the steps necessary to carry out the functions presented above with respect to the operation of the described apparatus and system. In one embodiment, the method begins as a fee is collected from a potential affiliate through the collection module. The affiliate receives access to design parameters and portions of software code, and is restricted from access to other portions of software code, including the core algorithms of the multimedia teaching system. The submitted code is compared to standards in the monitoring module, which is overseen by a monitor, or institution of learning. The driver code is then published in a downloadable, subsequent version of the software online. The percentages of total fees are allocated to the appropriate parties by the distribution module.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize that the invention may be practiced without one or more of the specific features or advantages of a particular embodiment. In other instances, additional features and advantages may be recognized in certain embodiments that may not be present in all embodiments of the invention.

These features and advantages of the present invention will become more fully apparent from the following description and appended claims, or may be learned by the practice of the invention as set forth hereinafter.

### BRIEF DESCRIPTION OF THE DRAWINGS

In order that the advantages of the invention will be readily understood, a more particular description of the invention briefly described above will be rendered by reference to specific embodiments that are illustrated in the appended drawings. Understanding that these drawings depict only typical embodiments of the invention and are not, therefore, to be considered to be limiting of its scope, the invention will be described and explained with additional specificity and detail through the use of the accompanying drawings, in which:

FIG. 1 is a schematic block diagram illustrating one embodiment of a multi-media teaching system, in accordance with the present invention;

FIG. 2 is a schematic block diagram illustrating one embodiment of a web-based, driver-development, coordinating apparatus, in accordance with the present invention;

FIG. 3 is a schematic block diagram illustrating a second embodiment of a web-based, driver-development, coordinating apparatus, in accordance with the present invention;

FIG. 4 is a schematic flow chart diagram illustrating the one embodiment of a method for coordinating web-based, driver design for a multi-media, teaching system, in accordance with the present invention; and

FIGS. 5A, 5B, and 5C are schematic flow chart diagrams illustrating a second embodiment of a method for coordinating web-based, driver design for a multi-media, teaching system, in accordance with the present invention.

### DETAILED DESCRIPTION OF THE INVENTION

Many of the functional units described in this specification have been labeled as modules, in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of executable code may, for instance, comprise one or more physical or logical blocks of computer instructions which may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Indeed, a module of executable code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network.

Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

Reference to a signal bearing medium may take any form capable of generating a signal, causing a signal to be generated, or causing execution of a program of machine-readable instructions on a digital processing apparatus. A signal bearing medium may be embodied by a transmission line, a compact disk, digital-video disk, a magnetic tape, a Bernoulli drive, a magnetic disk, a punch card, flash memory, integrated circuits, or other digital processing apparatus memory device.

Furthermore, the described features, structures, or characteristics of the invention may be combined in any suitable manner in one or more embodiments. In the following description, numerous specific details are provided, such as examples of programming, software modules, user selections, network transactions, database queries, database structures, hardware modules, hardware circuits, hardware chips, etc., to provide a thorough understanding of embodiments of the invention. One skilled in the relevant art will recognize, however, that the invention may be practiced without one or more of the specific details, or with other methods, components, materials, and so forth. In other instances, well-known structures, materials, or operations are not shown or described in detail to avoid obscuring aspects of the invention.

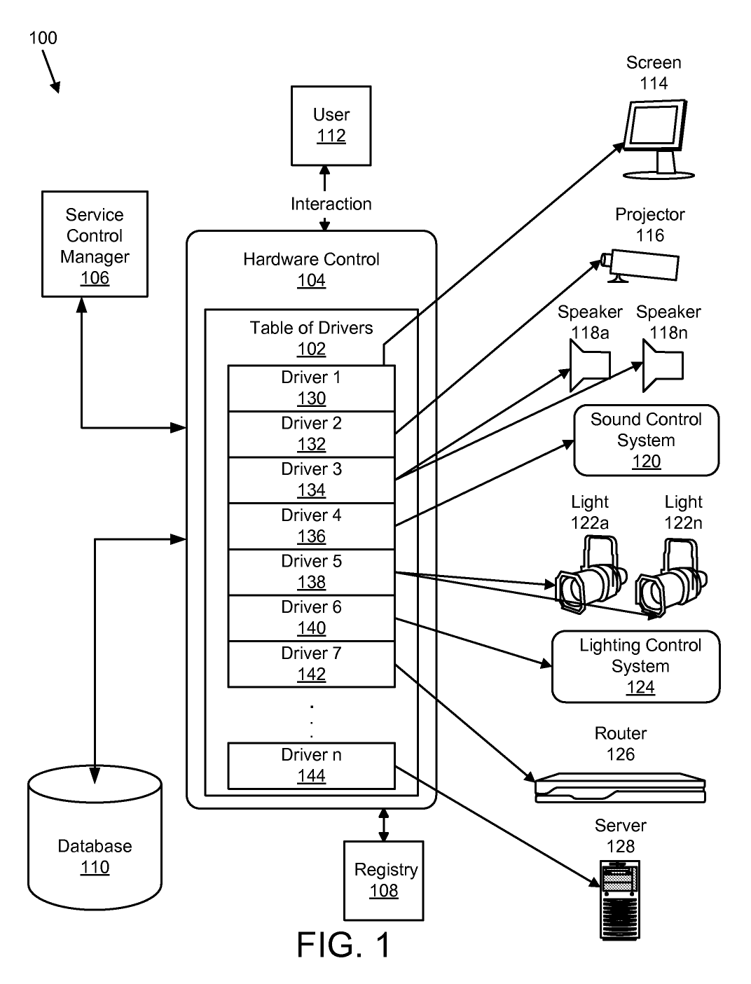

FIG. 1 depicts a system 100 for multimedia teaching in accordance with the present invention. The depicted system 100 includes a table of drivers 102, a hardware control 104, a service control manager 106, a registry 108, a database 110, a user 112, several pieces of hardware that facilitate the delivery of multimedia content 114-128, and several drivers 130-144 for those pieces of hardware 114-128. Although FIG. 1 depicts a single registry 108 and a single database 110, in certain embodiments, multiple registries 108a-n may be employed, as well as multiple databases 110a-n. The table of drivers 102, the hardware control 104, the service control manager 106, the registry or registries 108a-n, and the database(s) 110a-n may be stored on a single computer (not shown) or several computers connected one to another by a network (not shown). The various components of the system 100 function cooperatively to facilitate various modes of multimedia teaching.

The table of drivers 102 includes several drivers 130-144 used by the system 100 to control the multimedia sub-systems and/or pieces of hardware 114-128 necessary to deliver multimedia content. The hardware control 104 provides an interface between the drivers 114-128 of the table of drivers 102, the service control manager 106, the user 112, the registry, or registries, 108a-n, and the database(s) 110a-n.

The service control manager 106 comprises the software commands necessary to implement a session, or several sessions, of multimedia instruction. The service manager 106 provides information to the hardware control 104 that orchestrates the use of various multimedia sub-systems and/or pieces of hardware 114-128, such as screens 114 and speakers 118 used to instruct an audience. The service manager also provides information necessary to access content for display on the multimedia sub-systems and/or various pieces of hardware 114-128 via the registry, or registries, 108a-n, and the database(s) 110a-n, or otherwise.

The user 112, who may be a University Professor, or other type of instructor, may also provide instructions to the hardware control 104. In certain embodiments, commands from the user 112 override information from the service control manager 106. In certain embodiments, user 112 interaction turns off the service control manager 106. In other embodiments, user 112 interaction pauses the service control manager until the user interaction is addressed. In certain embodiments, user 112 interaction simply takes priority over the continuing stream of information from the service control manager 106 until the user 112 interaction ends and the information from the service control manager 106 takes over at an advanced stage.

Each multimedia sub-systems and/or piece of hardware 114-128 is controlled by a driver 114-128. For example, driver 1 (130) controls a screen 114; driver 2 (132) controls a projector 116; driver 3 (134) controls speakers 118a-n; driver 4 (136) controls a sound control system 120; driver 5 (138) controls lights 122a-b; driver 6 (140) controls a lighting control system 124; driver 7 (142) controls a router 126; and driver 8 (144) controls a server 128. The router 126 and the server 128 may be used to access content over a network (not shown) or multiple networks (not shown), or to similarly publish content.

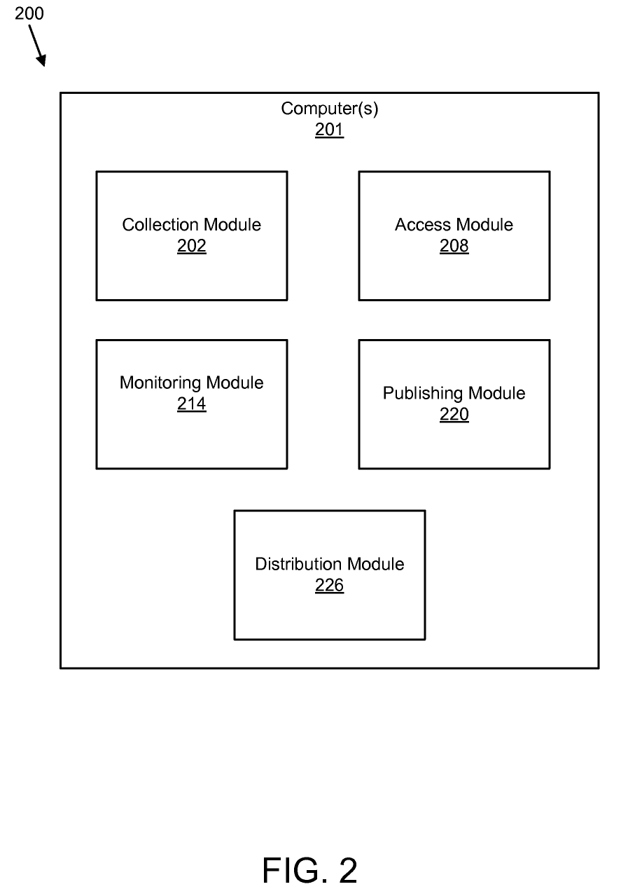

FIG. 2 depicts a schematic block diagram illustrating one embodiment of a web-based, driver-development, coordinating apparatus 200 stored on one or more computers 201. The apparatus, stored on one or more computers 201, may be located in the service control manager 106 and/or hardware control 104 of FIG. 1, or elsewhere. The apparatus 200 includes a collection module 202, an access module 208, a monitoring module 214, a publishing module 220, and a distribution module 226. The various modules of the apparatus 200 function cooperatively to facilitate web-based, driver-development for the multimedia, teaching system depicted in FIG. 1.

The collection module 202 provides information to potential affiliates (not shown), via the internet and/or world-wide-web (not shown), about opportunities to develop code for hardware drivers used by the proprietary multimedia teaching system of FIG. 1. Potential affiliates include universities and other institutions of learning who may benefit from the proprietary multimedia teaching system.

Institutions of learning who wish to expand the utility, capabilities, and configurations of the multimedia teaching system, while keeping cost savings to their institutions may become an affiliate through a license agreement (not shown). The license agreement allows the affiliate to write code for drivers that may be used by the multimedia teaching system to expand its utility, capabilities, and configurations.

The collection module 202 may present each potential affiliate with a copy of the license agreement with its respective terms. In exchange for a license to develop driver code, each affiliate pays a fee. In certain embodiments, the fee may be calculated as the sum of sub-fees assessed for each student (not shown) or programmer (not shown) developing code under the auspices of the affiliate. Once the terms of the license agreement are accepted and and the fee has been paid through a Graphical User Interfaces (“GUI”), or other facilitator known to those of skill in the relevant art, as provided by the collection module 202, the license agreement is executed. In certain embodiments, once a license agreement is executed, the collection module 202 generates a username (not shown) and a password (not shown) for the affiliate, which the collection module displays, in certain embodiments, to the user through a GUI and, in certain embodiments, emails to the user.

The access module 208 provides online access to design parameters for drivers that can be integrated into the multimedia teaching system. In certain embodiments, the access module 208 may also provide portions of source code supporting the multimedia teaching system that are necessary or helpful to develop and test new driver code. However, the access module actively restricts access to portions of the source code that contain the core algorithms of the multimedia teaching system through encryption or other methods known to those of skill in the relevant art.

The monitoring module 208 receives driver code (not shown) submitted by affiliates online. The monitoring module compares the submitted driver code against standards (not shown). The standards against which the monitoring module 208 compares the driver code and the operations of the monitoring module are administered by a monitor (not shown). The monitor may be a university, a committee, or some other institution of learning. In certain embodiments, the monitor determines the standards. In other embodiments, the owner of intellectual property in the multimedia teaching system determines the standards.

The publishing module 220 receives driver code from the monitoring module 214 that satisfies the standards against which it was checked by the monitoring module 214. The publishing module 220 then publishes this driver code in successive versions of the software that supports the multimedia teaching system. The publishing module 220 makes the successive versions of the software available online. Driver code that satisfies the standards becomes an additional driver similar to the drivers 130-144 included in the table of drivers drivers 102 depicted in FIG. 1.

The distribution module 226 calculates the total sum for the fees collected by the collection module 202. The distribution module 226 then calculates a percentage of the total sum to be received by the monitor by way of compensation for services rendered in administering the standards and the operation of the monitoring module 214. The distribution module 226 also calculates a percentage to be received by the owner of the intellectual property rights in the multimedia teaching system. In certain embodiments, the distribution module 226 calculates a percentage for other parties. The distribution module 226 then facilitates an electronic transfer of funds so that each party receives its proper share of the total fees collected by the collection module 202.

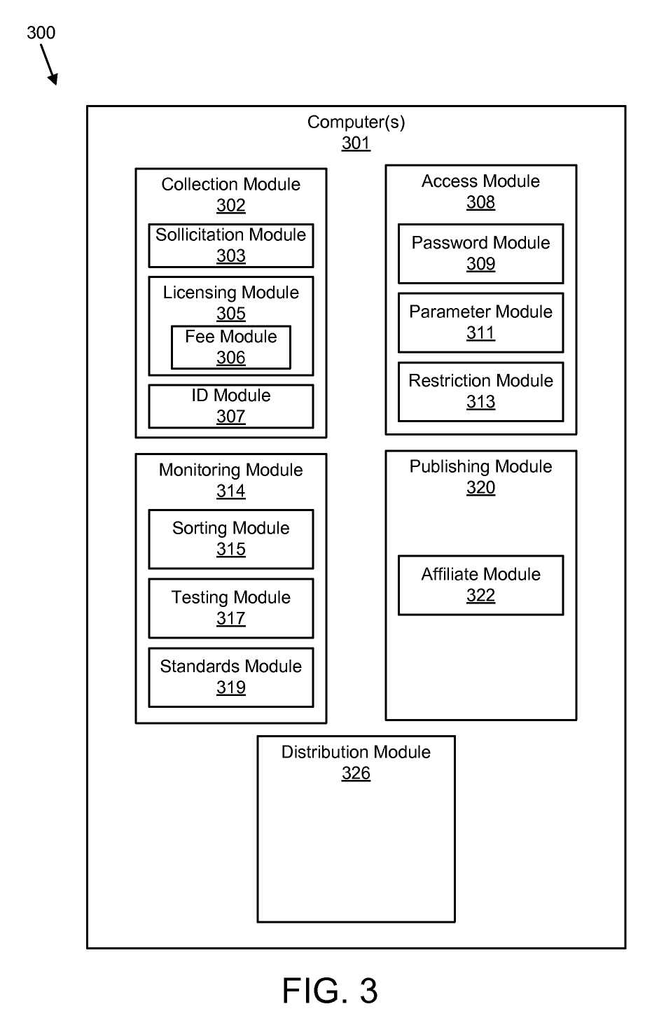

FIG. 3 depicts a schematic block diagram illustrating a second embodiment of a web-based, driver-development, coordinating apparatus 300 stored on one or more computers 301. The apparatus 300 includes a collection module 302, an access module 308, a monitoring module 314, a publishing module 320, and a distribution module 326. The various modules of the apparatus 300 function cooperatively to facilitate web-based, driver-development for the multimedia, teaching system depicted in FIG. 1.

The collection module 302, the access module 308, the monitoring module 314, the publishing module 320, and the distribution module 326 perform operations substantially similar to those discussed above. However, the collection module 302 includes both a solicitation module 303, a licensing module 305, and an identification module 307. The solicitation module 303 promulgates information to universities and institutions of learning (not shown) about the opportunity of becoming an affiliate licensed to write code for the multimedia teaching system of FIG. 1.

In certain embodiments, the solicitation module 303 promulgates information by maintaining a web page (not shown). In certain embodiments, the solicitation module 303 promulgates information by sending emails (not shown) to administrators of universities and institutions of learning. In some embodiments, the emails contain links to a web-page.

The licensing module 305 displays the terms of the license agreement (not shown) on a web page. In certain embodiments, the licensing module 305 includes a fee module 306 that provides a GUI, or other facilitator known to those in the relevant art, that facilitates the payment of a fee in connection with the license agreement. The licensing module 305 provides a link to a GUI, or other facilitator, that facilitates the payment. The fee module 306 may provide an encryption operation, or other methods known to those of skill in the relevant art, to protect information and to insure secure transmission of funds.

In certain embodiments, once the fee transaction has been completed by the fee module 306, the licensing module 305 displays a button, link, box, or similar functionality that allows a potential affiliate to accept the terms of the license agreement. In such embodiments, once the terms of the license agreement are accepted, the license agreement is executed.

In certain embodiments, once the license agreement is executed, the identification module 307 generates a username (not shown) and a password (not shown) for the affiliate making the required payment and agreeing to the license agreement. In certain embodiments, the identification module displays the username and password on the web page displaying the terms of the license agreement. In certain embodiments, the identification module emails the user identification and password to an email address collected by the identification module 307. In certain embodiments, the password module stores the username and password in a database (not shown).

The access module 308 includes a password module 309, a parameter module 311, and a restriction module 313. The password module 309 displays a GUI, or other facilitator known to those in the relevant art, requesting the username and password generated by the identification module 307. The password module 309 checks the user identification and password input against the usernames and passwords stored in by the identification module 307.

Once a match is found for the username and password in the database, the parameter module 311 displays to a web page (not shown), design parameters for the development of drivers for use with the multimedia teaching system. The parameter module 311 may also display additional instructions and standards. The parameter module 311 also delivers portions of the source code for the multimedia teaching system that are necessary or helpful to develop and/or test driver code.

The restriction module 313 takes active measures to prevent access to the core algorithms in the software supporting the multimedia teaching system. Such active measures may include isolating the relevant portions of the code and encrypting these portions. Other measures will be apparent to those of ordinary skill in the relevant art in light of the present disclosure.

The monitoring module 314 includes a sorting module 315, a testing module 317, and a standards module 319. The sorting module 315 sorts submitted driver code into categories. In certain embodiments, the sorting module groups driver code by the multimedia sub-systems or hardware to which the driver provides an interface. In certain embodiments, the sorting module reads the code and isolates and groups important functions or other portions of code.

The testing module 317 applies certain predefined tests to the driver code or portions of the driver code and collects the results. In certain embodiments, the testing module 317 collects test data from the affiliate responsible for submitting the driver code. The standards module 319 compares the driver code, or relevant portions of the code to a set of standards (not shown). In certain embodiments, the standards module 319 also compares the results generated and/or collected by the testing module 317 against certain standards.

The publishing module 320 includes an affiliate module 322. The affiliate module 322 prevents access to subsequent versions of the software supporting the multimedia teaching system to licensed affiliates. In certain embodiments, the affiliate module restricts access to downloadable versions of the software by requiring a username and a password, as and a password, as generated by the identification module 307.

The schematic flow chart diagrams that follow are generally set forth as logical flow chart diagrams. As such, the depicted order and labeled steps are indicative of one embodiment of the presented method. Other steps and methods may be conceived that are equivalent in function, logic, or effect to one or more steps, or portions thereof, of the illustrated method. Additionally, the format and symbols employed are provided to explain the logical steps of the method and are understood not to limit the scope of the method. Although various arrow types and line types may be employed in the flow chart diagrams, they are understood not to limit the scope of the corresponding method. Indeed, some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown.

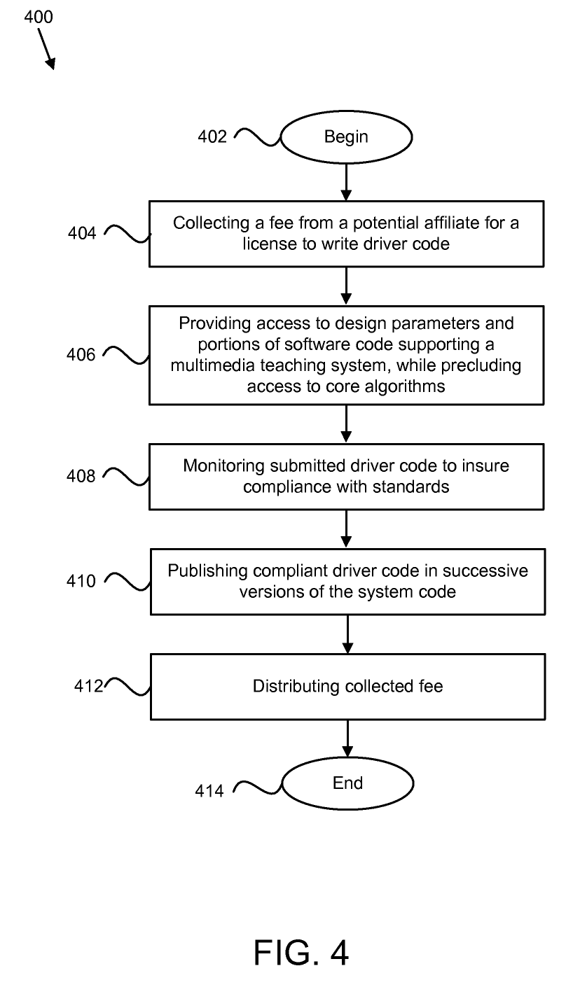

FIG. 4 depicts a schematic flow chart diagram illustrating one embodiment of a method 400 for facilitating web-based, driver-development. The method 400 begins 402 and the collection module 202 collects 404 a fee from a potential affiliate who becomes an affiliate after executing a license agreement. The method 400 continues by providing 406 the affiliate access to design parameters and portions of software code supporting a multimedia teaching system necessary to write code for drivers pertaining to the system. However, the operation of providing 406 access to certain portions of software code also includes preventing access to other portions of the software code. The restricted portions of software code include all code embodying the core algorithms of the multimedia teaching system that control multi patterns of multi i/o sources to multiple screens via proprietary educational delivery system, that triggers higher whole brain participation to any conventional class room learning environment, learning environment. The operation of providing 406 access to design parameters and to certain portions of code while restricting access to other portions is implemented by the access module 208.

Once affiliates have made use of the design parameters and portions of code provided them to write code for additional drivers and have submitted the code, monitoring 408 of the submitted code begins. The monitoring module 214 compares the submitted code to standards to insure compliance with those standards. The step of monitoring 408 submitted code is overseen by a monitor, which in certain impediments may be a university. The publishing module 220 then publishes 410 compliant driver code in downloadable, subsequent versions of the software online.

At certain predefined intervals, the distribution module 226 distributes 412 fees collected by the collection module 202. The distribution module 226 allocates a percentage of the total fees collected by the collection module 202 to the monitor administering the monitoring module 226 and the standards used to monitor 408 submitted code. The distribution module 226 also allocates a percentage of the total fees to the owner of the intellectual property rights for the multimedia teaching system. The distribution module 226 may make additional allocations.

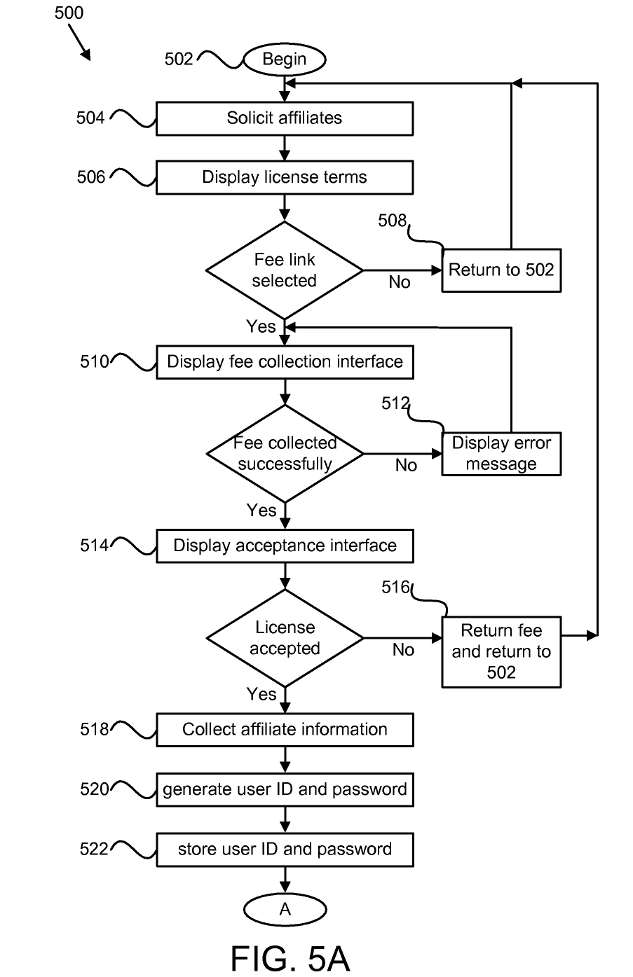

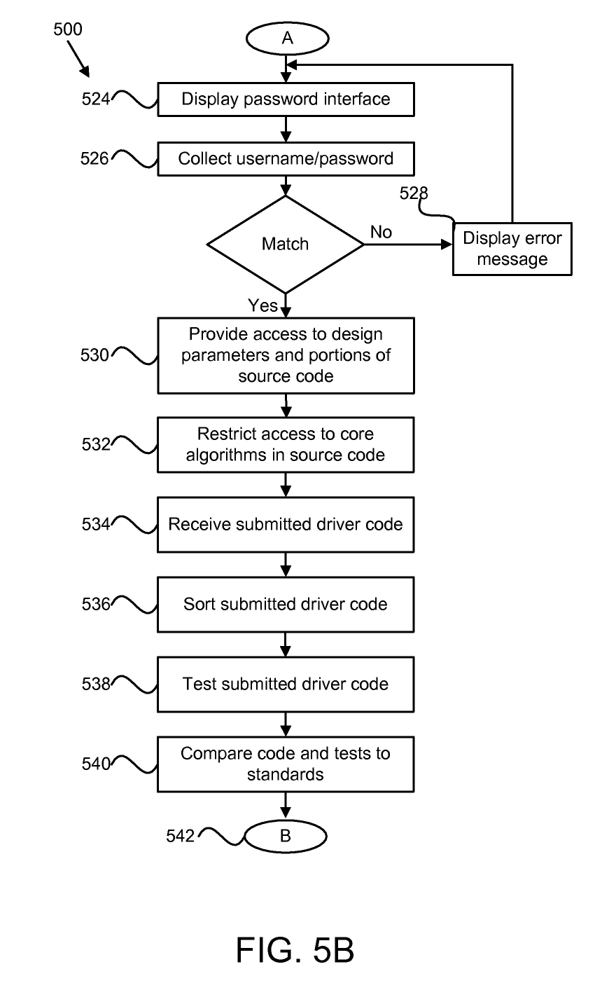

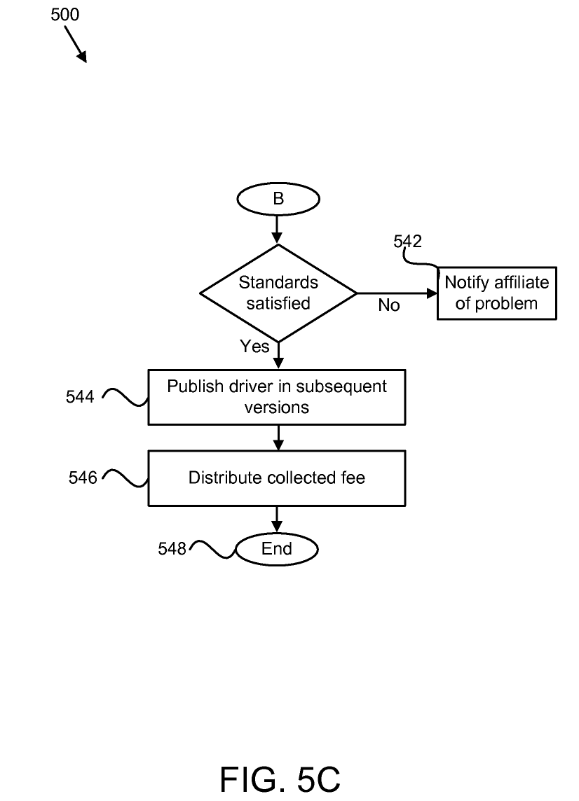

FIG. 5 depicts a schematic flow chart diagram illustrating a second embodiment of a method 500 for facilitating web-based, driver-development. The method 500 begins 502 and the solicitation module 303 solicits 504 potential licensed affiliates by promulgating information, as discussed above, about the opportunity to become licensed to write driver code for a multimedia teaching system. In certain embodiments, the licensing module 305 displays 506 the terms of a licensing agreement as part of the solicitation. The licensing agreement grants a license to write code for a multimedia teaching system.

The licensing agreement displayed by the licensing module 305 includes a link for paying a fee in connection with the license agreement. Should a potential affiliate fail to select the link, the method 500 returns 508 and begins 502 with another potential affiliate, affiliate. Should the potential affiliate select the fee link, the fee module 306 displays 510 a fee collection interface. If the potential affiliate does not provide necessary information or provides incorrect information, the fee module 306 displays 512 an error message that requests additional information of the potential affiliate and/or informs the potential affiliate of problems with the submitted information before displaying 510 the fee collection interface.

If the potential affiliate provides the requisite information and the fee is successfully collected, the licensing module 305, in certain embodiments, displays 514 an acceptance interface, which provides a box, a button, or some other pathway to accept the terms of the license agreement. If the potential affiliate fails to accept the terms of the license agreement, the fee is returned by the fee module 306 and the method 500 returns 516 and begins 502 with another potential affiliate. If the potential affiliate accepts the terms of the license agreement, the identification module 307 collects 518 information necessary to generate a username and a password through an interface. The identification module 307 generates 520 and stores 522 a username and a password.

The method 500 continues and the password module 309 displays 524 a password interface. The password module 309 collects 526 a username and a password. If the username and password collected by the password module 309 fail to match a username and a password stored by the identification module 307, an error message is displayed 528 and the method 500 returns to displaying 524 the password interface. If the username and password collected by the password module 309 match a username and a password stored by the identification module 307, the parameter module 311 provides 530 access to design parameters and portions of source code. The restriction module 313 restricts 532 access to core algorithms in source code.

The method continues 500 and the monitoring module 314 receives 534 driver code submitted by a licensed affiliate. The sorting module 315 sorts 536 submitted driver code, as discussed above. The testing module 317 tests 538 the submitted driver code, or portions of the driver code. The standards module 319 compares 540 code and tests to standards. If the standards are not satisfied by tests or code, the affiliate submitting the underlying code is notified 542, in some embodiments by email, of the problem. The steps of receiving 534, sorting 536, testing 538, and comparing 540 code are overseen by a monitor, in some embodiments a university or institution of learning.

If the standards are satisfied by tests and/or code, the publishing module 320 publishes 544 the driver code in subsequent versions of the software supporting the multimedia teaching system, as discussed above. The method 500 continues and the distribution module 326 distributes 546 the fees collected by the fee module 306 at predefined intervals. The distribution module 326 calculates percentages of the total sum of fees collected by the fee module 306 to be received by a party monitoring the steps 534-540 involved in monitoring submitted code and by the owner of the intellectual property rights in the multimedia teaching system. In certain embodiments, the distribution module 226 calculates a percentage for other parties. In certain embodiments, the distribution module 226 then facilitates an electronic transfer of funds so that each party receives its proper share of the total fees. The method 500 then ends 548.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A system for enhanced learning, the system comprising:
a service control manager comprising the software commands;
a database, wherein relevant information is stored;
a registry, wherein relevant information and programs are stored;
a server, wherein information is served to other computers;
a router, wherein data is transmitted over the internet to the appropriate locations;
lights, by which the information is transmitted;
speakers, through which sound accompanying the presentation is heard;
a lighting control system, comprising controls for the adjustment of the lights;
a sound control system, comprising controls for the increase and decrease in sound;
a projector, through which the information is displayed;
and a screen, upon which the information will be displayed; and
a table of drivers, comprising drivers that control the screen,
the projector, the speakers, the sound control system, the lights, the lighting control system, the router, and the server.

2. The apparatus in claim 1, wherein the service control manager provides information to the hardware control.

3. The apparatus in claim 2, wherein the hardware control orchestrates the use of multimedia sub-systems.

4. The apparatus in claim 2, wherein the hardware control orchestrates the use of pieces of hardware.

5. The apparatus in claim 1, wherein the relevant information includes usernames and passwords.

6. An apparatus for enhanced learning, the apparatus comprising:
a collection module to present copies of agreements and terms comprising:
a solicitation module to maintain a web-page, and send correspondence to affiliates;
an identification module to make usernames and passwords;
a licensing module to display and store the terms of agreements, comprising:
a fee module that facilitates the payment of a fee;
an access module to design parameters for drivers comprising:
a password module to check a user's password;
a parameter module to display parameters, instructions, standards, and source codes;
a restriction module to prevent the release of core algorithms to user;
a monitoring module to monitor the driver codes comprising:
a sorting module to sort driver codes;
a testing module to apply predefined tests to driver codes;
a standards module to compare the driver code to predetermined standards;
a publishing module to publish driver codes into software comprising:
an affiliate module to prevent access to subsequent versions of the software; and
a distribution module to calculate sums owed to each party and to facilitate an electronic transfer of funds.

7. The apparatus in claim 6, wherein the facilitator of the fee is a GUI.

8. A method for coordinating the web-based development of drivers for hardware units used in connection with a multimedia teaching system, the method comprising:
collecting online a fee from a plurality of affiliates paying for a license to write computer readable code for a plurality of drivers (“driver code”) used to integrate components into a multimedia teaching system or software modules needed to coordinate various projectors routers and facilities owned or to be acquired by any teaching organization for the purpose of an end system for the purposes set forth here;
providing online access to the plurality of affiliates to design parameters and portions of computer readable code supporting the multimedia teaching system (“system code”) that are necessary to write the driver code, and software interfaces while precluding the plurality of affiliates from affiliates from accessing core algorithms supporting the multimedia teaching system in the system code;
monitoring by a monitor the driver code submitted online by the plurality of affiliates to insure compliance with documented standards for the system code;
publishing compliant driver code in successive versions of the system code; and
distributing online proceeds from the fee between the monitor and an owner of intellectual property in the multimedia teaching system.
